(19) United States
(12) Patent Application Publication
(10) Pub. No.: US 2024/0288758 A1
(43) Pub. Date: Aug. 29, 2024

(54) LIGHT SOURCE APPARATUS AND PROJECTOR

(71) Applicant: SEIKO EPSON CORPORATION, Tokyo (JP)

(72) Inventor: Soma TODA, MATSUMOTO-SHI (JP)

(21) Appl. No.: 18/589,735

(22) Filed: Feb. 28, 2024

(30) Foreign Application Priority Data
Feb. 28, 2023 (JP) 2023-029316

(51) Int. Cl. G03B 21/20

(52) U.S. Cl. CPC G03B 21/2053; G03B 21/2013; G03B 21/2033; G03B 21/208

(57) ABSTRACT

A light source apparatus according to an aspect of the present disclosure includes a first light source that outputs a first luminous flux, a second light source that outputs a second luminous flux, a combiner, a width adjuster that reduces the difference in width between the first luminous flux and the second luminous flux, a first light collection system, a first diffuser, a second light collection system, and a homogenizing system. The first luminous flux traveling via the width adjuster, the combiner, and the first light collection system is collected at a first position, and the second luminous flux traveling via the combiner and the first light collection system is collected at a second position. The width adjuster and the first light collection system approach the aspect ratio and size of a first image formed by the first luminous flux to those of a second image formed by the second luminous flux.

The present application is based on, and claims priority from JP Application Serial Number 2023-029316, filed Feb. 28, 2023, the disclosure of which is hereby incorporated by reference herein in its entirety.

### BACKGROUND

### 1. Technical Field

The present disclosure relates to a light source apparatus and a projector.

### 2. Related Art

There is a light source apparatus for projectors of related art, the light source apparatus including a blue light source that outputs blue light, a red light source that outputs red light, a green light source that outputs green light, and a dichroic mirror that combines the variety of types of color light output from the light sources (see JP-A-2009-259583, for example).

JP-A-2009-259583 is an example of the related art.

In the light source apparatus using the light sources that output the variety of different types of color light as described above, the light emitting regions of the light sources have different sizes according to the efficiencies at which the variety of types of color light are output, so that the light source images formed on an optical member by the variety of types of color light have different aspect ratios. When the light source images formed by the variety of types of color light have different aspect ratios as described above, light beam truncation occurs in an illumination system located at a position downstream from the optical member, resulting in a problem of a decrease in the efficiency at which the light output from the light source apparatus is used.

### SUMMARY

To solve the problem described above, according to an aspect of the present disclosure, there is provided a light source apparatus including a first light source part that outputs a first luminous flux containing first color light emitted from a first light emitting region, a second light source part that outputs a second luminous flux containing second color light emitted from a second light emitting region having a planar shape different from a planar shape of the first light emitting region and having a wavelength band different from a wavelength band of the first color light, a combiner that combines the first luminous flux and the second luminous flux with each other, a luminous flux width adjuster that is disposed between the combiner and the first light source part and adjusts to reduce a difference in a luminous flux width between the first luminous flux and the second luminous flux, a first light collection system that collects light output from the combiner, a first diffuser that the light output from the first light collection system enters, a second light collection system that light output from the first diffuser enters, and a homogenizing illumination system that light output from the second light collection system enters, the luminous flux width adjuster having a finite focal length, the first luminous flux output from the first light source part and traveling via the luminous flux width adjuster, the combiner, and the first light collection system collected at a first light collection position on a line extending in an optical axis direction of the first light collection system, the second luminous flux output from the second light source part and traveling via the combiner and the first light collection system collected at a second light collection position different from the first light collection position in the optical axis direction, and the luminous flux width adjuster and the first light collection system collecting the first luminous flux in such a way that an aspect ratio and a size of a first light source image formed by the first luminous flux at a light incident surface of the first diffuser approach an aspect ratio and a size of a second light source image formed by the second luminous flux at the light incident surface of the first diffuser.

According to another aspect of the present disclosure, there is provided a projector including the light source apparatus described above, a light modulator that modulates light from the light source apparatus to generate image light, and a projection optical apparatus that projects the image light.

### BRIEF DESCRIPTION OF THE DRAWINGS

FIG. 1 shows a schematic configuration of a projector according to an embodiment.

FIG. 2 shows a schematic configuration of a light source apparatus.

FIG. 3 conceptually shows light source images formed on a first diffuser.

FIG. 4 shows the light source image of a red luminous flux formed on the first diffuser in Comparative Example.

FIG. 5 shows the light source image of a green luminous flux formed on the first diffuser.

FIG. 6 shows the light source image formed on a light incident surface of the first diffuser.

FIG. 7 shows the results of a simulation on the focal lengths of first and second light collection systems.

### DESCRIPTION OF EMBODIMENTS

An embodiment of the present disclosure will be described below in detail with reference to the drawings.

In the drawings used in the description below, a characteristic portion is enlarged for convenience in some cases for clarity of the characteristic thereof, and the dimension ratio and other factors of each component are therefore not always equal to actual values.

### First Embodiment

An example of a projector according to the present embodiment will first be described.

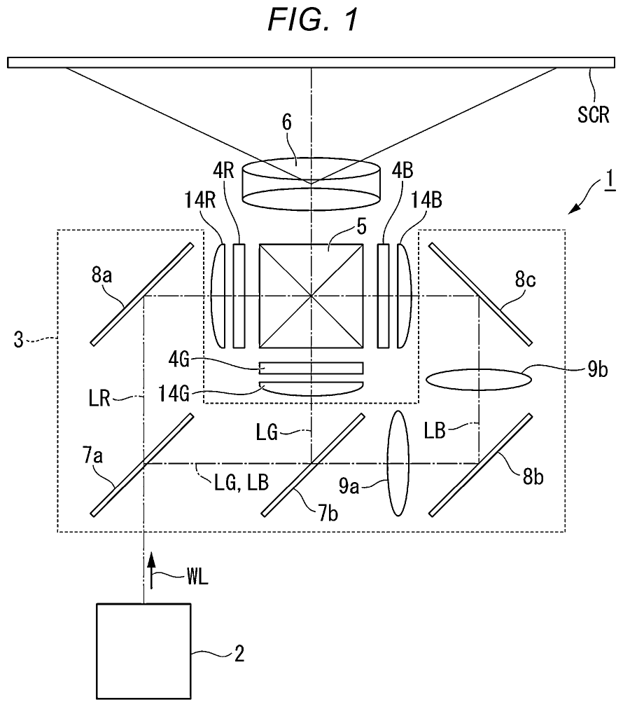

FIG. 1 shows a schematic configuration of the projector according to the present embodiment.

A projector 1 according to the present embodiment is a projection-type image display apparatus that displays color video images on a screen SCR, as shown in FIG. 1. The projector 1 includes a light source apparatus 2, a color separation system 3, light modulators 4R, 4G, and 4B, a light combining system 5, and a projection optical apparatus 6.

The color separation system 3 separates white illumination light WL output from the light source apparatus 2 into red light LR, green light LG, and blue light LB. The color separation system 3 includes a dichroic mirror 7a, a dichroic mirror 7b, a total reflection mirror 8a, a total reflection mirror 8b, a total reflection mirror 8c, a first relay lens 9a, and a second relay lens 9b.

The dichroic mirror 7a separates the illumination light WL from the light source apparatus 2 into the red light LR and the other light (green light LG and blue light LB). The dichroic mirror 7a transmits the red light LR and reflects the other light. The dichroic mirror 7b reflects the green light LG and transmits the blue light LB.

The total reflection mirror 8a reflects the red light LR toward the light modulator 4R. The total reflection mirrors 8b and 8c guide the blue light LB to the light modulator 4B. The dichroic mirror 7b guides the green light LG to the light modulator 4G.

The first relay lens 9a is disposed in the optical path of the blue light LB between the dichroic mirror 7b and the total reflection mirror 8b. The second relay lens 9b is disposed in the optical path of the blue light LB between the total reflection mirror 8b and the total reflection mirror 8c.

The light modulator 4R modulates the red light LR in accordance with image information to form red image light. The light modulator 4G modulates the green light LG in accordance with image information to form green image light. The light modulator 4B modulates the blue light LB in accordance with image information to form blue image light.

The light modulators 4R, 4G, and 4B are each, for example, a transmissive liquid crystal panel. Polarizers that are not shown are disposed on the light incident side and the light exiting side of each of the liquid crystal panels.

Field lens 14R, 14G, and 14B are disposed at the light incident side of the light modulators 4R, 4G, and 4B, respectively.

The variety of types of image light from the light modulators 4R, 4G, and 4B enter the light combining system 5. The light combining system 5 combines the variety of types of image light with one another and outputs the combined image light toward the projection optical apparatus 6. The light combining system 5 is formed, for example, of a cross dichroic prism.

The projection optical apparatus 6 is formed of a projection lens group, enlarges the combined image light from the light combining system 5, and projects the enlarged image light toward the screen SCR. Enlarged color video images are thus displayed on the screen SCR.

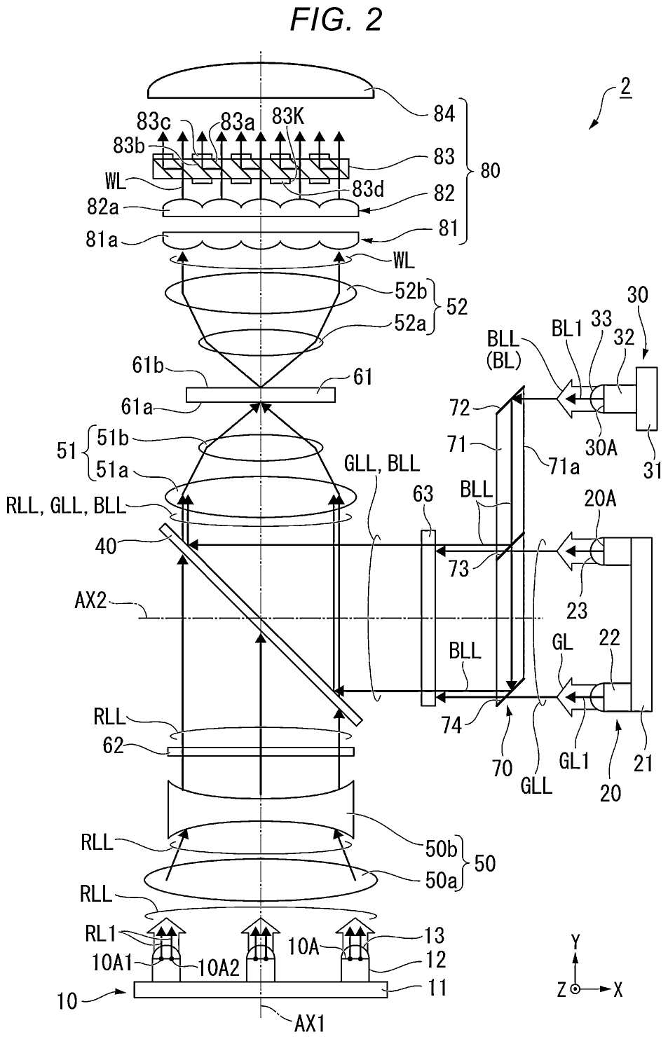

The light source apparatus 2 according to the present embodiment will be subsequently described. FIG. 2 shows a schematic configuration of the light source apparatus 2.

In the following description, the configuration and layout of members of the light source apparatus 2 will be described by using an XYZ orthogonal coordinate system as the coordinate axes. It is assumed in the present embodiment that the direction in which the illumination light WL is output from the light source apparatus 2 is the direction toward the positive end of the Y-axis, that the direction in which a green luminous flux GLL and a blue luminous flux BLL are output from a luminous flux width changer 70, which will be described later, is the direction toward the negative end of the X-axis, and that the direction perpendicular to the X-axis and the Y-axis and extending from the far side toward the near side of the plane of view is the direction toward the positive end of the Z-axis.

The light source apparatus 2 according to the present embodiment includes a first light source part 10, a second light source part 20, a third light source part 30, a dichroic mirror 40, a luminous flux width adjuster 50, a first light collection system 51, a second light collection system 52, a first diffuser 61, a second diffuser 62, a third diffuser 63, the luminous flux width changer 70, and a homogenizing illumination system 80, as shown in FIG. 2. In the present embodiment, the dichroic mirror 40 corresponds to a “combiner”.

In the light source apparatus 2 according to the present embodiment, the first light source part 10, the luminous flux width adjuster 50, the second diffuser 62, the dichroic mirror 40, the first light collection system 51, the first diffuser 61, the second light collection system 52, and the homogenizing illumination system 80 are arranged along the Y-axis. The second light source part 20, the luminous flux width changer 70, the third diffuser 63, and the dichroic mirror 40 are arranged along the X-axis.

The first light source part 10 includes a substrate 11, a plurality of red light emitting devices 12 disposed on the substrate 11, and a plurality of collimation lenses 13 provided at the light emitting surfaces of the red light emitting devices 12. The first light source part 10 includes a plurality of first light emitting regions 10A, which emit red light RL having a red wavelength band. In the first light source part 10, a pair of red light emitting device 12 and collimation lens 13 are disposed at each of the first light emitting regions 10A. The number of first light emitting regions 10A in the first light source part 10 is not limited to a specific number and may be one. In the present embodiment, the red light RL emitted from each of the first light emitting regions 10A of the first light source part 10 corresponds to “first color light”.

The red light emitting devices 12 each output a red beam having a peak wavelength that falls within a range, for example, from 585 to 720 nm. In general, the red light emitting devices 12 emit light having luminance lower than the luminance of the light emitted from blue and green light emitting devices. Therefore, in the present embodiment, the red light emitting devices 12 are each formed, for example, of a one-chip-two-emitter semiconductor laser that emits red beams RL1 from two light emitting points. The collimation lenses 13 each convert the red light RL formed of the two red beams RL1 output from the corresponding red light emitting device 12 into parallelized light.

In the present embodiment, the first light emitting regions 10A of the first light source part 10 each include a first light emitting section 10A1, which emits one of the two red beams RL1, and a second light emitting section 10A2, which emits the other one of the two red beams RL1. That is, the first light emitting regions 10A each have two light emitting points.

The first light source part 10 in the present embodiment is configured to output a red luminous flux RLL, which is a parallelized version of the plurality of beams of the red light RL emitted from the first light emitting regions 10A. In the present embodiment, the red luminous flux RLL output from the first light source part 10 corresponds to a “first luminous flux”. The center axis of the red luminous flux RLL output from the first light source part 10 is defined as a first optical axis AX1. The first optical axis AX1 is an axis parallel to the Y-axis.

The second light source part 20 includes a substrate 21, a plurality of green light emitting devices 22 disposed on the substrate 21, and a plurality of collimation lenses 23 provided at the light emitting surfaces of the green light emitting devices 22. The second light source part 20 includes a plurality of second light emitting regions 20A, which emit green light GL having a green wavelength band. In the second light source part 20, a pair of green light emitting device 22 and collimation lens 23 are disposed at each of the second light emitting regions 20A. The number of second light emitting regions 20A in the second light source part 20 is not limited to a specific number and may be one. In the present embodiment, the green light GL emitted from each of the second light emitting regions 20A of the second light source part 20 corresponds to “second color light”.

The green light emitting devices 22 each output a green beam having a peak wavelength that falls within a range, for example, from 500 to 570 nm. In the present embodiment, the green light emitting devices 22 are each formed, for example, of a one-chip-one-emitter semiconductor laser that emits a green beam GL1 from one light emitting point. The collimation lenses 23 each convert the green light GL formed of one green beam GL1 output from the corresponding green light emitting device 22 into parallelized light.

In the present embodiment, the second light emitting regions 20A of the second light source part 20 differ from the first light emitting regions 10A of the first light source part 10 and each have one light emitting point.

The second light source part 20 in the present embodiment is configured to output the green luminous flux GLL, which is a parallelized version of the green light GL emitted from the second light emitting regions 20A. In the present embodiment, the green luminous flux GLL output from the second light source part 20 corresponds to a “second luminous flux”. The center axis of the green luminous flux GLL output from the second light source part 20 is defined as a second optical axis AX2. The second optical axis AX2 is an axis parallel to the X-axis.

The third light source part 30 includes a substrate 31, a plurality of blue light emitting devices 32 disposed on the substrate 31, and a plurality of collimation lenses 33 provided at the light emitting surfaces of the blue light emitting devices 32. The third light source part 30 includes a plurality of third light emitting regions 30A, which emit blue light BL having a blue wavelength band. In the third light source part 30, a pair of blue light emitting device 32 and collimation lens 33 are disposed at each of the third light emitting regions 30A. The number of third light emitting regions 30A in the third light source part 30 is not limited to a specific number and may be one. In the present embodiment, the blue light BL emitted from each of the third light emitting regions 30A of the third light source part 30 corresponds to “third color light”.

The blue light emitting devices 32 each output a blue beam having a peak wavelength that falls within a range, for example, from 440 to 470 nm. In the present embodiment, the blue light emitting devices 32 are each formed, for example, of a one-chip-one-emitter semiconductor laser that emits a blue beam BL1 from one light emitting point. The collimation lenses 33 each convert the blue light BL formed of one blue beam BL1 output from the corresponding blue light emitting device 32 into parallelized light.

In the present embodiment, the third light emitting regions 30A of the third light source part 30 differ from the first light emitting regions 10A of the first light source part 10 and each have one light emitting point.

The third light source part 30 in the present embodiment is configured to output the blue luminous flux BLL, which is a parallelized version of the blue light BL emitted from the third light emitting regions 30A. In the present embodiment, the blue luminous flux BLL output from the third light source part 30 corresponds to a “third luminous flux”.

In the present embodiment, the first light emitting regions 10A and the second light emitting regions 20A have different planar shapes. Specifically, in the present embodiment, the second light emitting regions 20A or the third light emitting regions 30A, which each have one light emitting point, have a substantially square planar shape having an aspect ratio being approximately one. That is, the aspect ratio of each of the second light emitting regions 20A or the third light emitting regions 30A is close to 1:1.

In contrast, the first light emitting regions 10A, which each have two light emitting points, have a rectangular planar shape or a laterally elongated square planar shape as compared with the planar shape of each of the second light emitting regions 20A or the third light emitting regions 30A. That is, the aspect ratio of each of the first light emitting regions 10A is more separate from 1:1 than the aspect ratio of each of the second light emitting regions 20A and the third light emitting regions 30A.

Therefore, in the light source apparatus 2 according to the present embodiment, the second light emitting regions 20A and the third light emitting regions 30A each have an aspect ratio closer to 1:1 than the first light emitting regions 10A.

As described above, the first light emitting regions 10A and the second light emitting regions 20A have difference planar shapes and sizes, and so do the first light emitting regions 10A and the third light emitting regions 30A.

In the present embodiment, the red luminous flux RLL output from the first light source part 10 enters the luminous flux width adjuster 50. The luminous flux width adjuster 50 is disposed between the dichroic mirror 40 and the first light source part 10 and reduces the difference in the luminous flux width between the red luminous flux RLL and the green luminous flux GLL. The luminous flux width adjuster 50 in the present embodiment is configured to reduce the luminous flux width of the red luminous flux RLL so that the red luminous flux RLL and the green luminous flux GLL have the same luminous flux width.

In the present embodiment, the luminous flux width adjuster 50 is formed of a first lens 50a and a second lens 50b. The first lens 50a is formed of a convex lens, and the second lens 50b is formed of a concave lens. The luminous flux width adjuster 50 reduces the luminous flux width of the red luminous flux RLL so that the red luminous flux RLL and the green luminous flux GLL have the same luminous flux width. The configuration described above can suppress an increase in the size of the dichroic mirror 40, which will be described later and combines the red luminous flux RLL and the green luminous flux GLL with each other.

In the present embodiment, the luminous flux width adjuster 50 has a finite focal length. The red luminous flux RLL incident as a parallelized luminous flux on the luminous flux width adjuster 50 from the first light source part 10 is therefore converted into divergent or convergent light instead of parallelized light by the luminous flux width adjuster 50 when passing therethrough.

The red luminous flux RLL the luminous flux width of which has been adjusted by the luminous flux width adjuster 50 enters the second diffuser 62. The second diffuser 62 is disposed between the first light source part 10 and the dichroic mirror 40.

The second diffuser 62 can homogenize the illuminance distribution of the red luminous flux RLL by diffusing the red luminous flux RLL. Furthermore, the second diffuser 62 suppresses speckles produced in the red luminous flux RLL, which degrade the quality of a displayed image. Note that the second diffuser 62 can be any known diffuser plate, for example, a ground glass plate, a holographic diffuser, a transparent substrate having blasted surfaces, and a transparent substrate in which scatterers such as beads are dispersed and scatter light.

The red luminous flux RLL diffused by the second diffuser 62 is incident on the dichroic mirror 40.

In the present embodiment, the green luminous flux GLL output from the second light source part 20 and the blue luminous flux BLL output from the third light source part 30 enter the luminous flux width changer 70. The luminous flux width changer 70 causes the luminous flux width of the blue luminous flux BLL and the luminous flux width of the green luminous flux GLL to approach each other and combines the blue luminous flux BLL and the green luminous flux GLL with each other.

The luminous flux width changer 70 includes a lightguide member 71, a first reflector 72, a second reflector 73, and a third reflector 74. In the present embodiment, the first reflector 72, the second reflector 73, and the third reflector 74 are provided as part of the lightguide member 71. That is, the luminous flux width changer 70 is formed of a single member into which the first reflector 72, the second reflector 73, the third reflector 74, and the lightguide member 71 are integrated with each other.

The lightguide member 71 is made of optical glass, quartz, or any other light transmissive material and has a substantially quadrangular columnar shape. The lightguide member 71 has a light incident surface 71a, which faces the second light source part 20 and the third light source part 30. The lightguide member 71 guides the blue luminous flux BLL through the space between the third reflector 74 and the first reflector 72 and the space between the first reflector 72 and the second reflector 73.

The first reflector 72 is provided as part of the lightguide member 71 and at a position where the first reflector 72 faces the third light source part 30. The first reflector 72 inclines by 45 degrees with respect to the light incident surface 71a of the lightguide member 71. The first reflector 72 reflects the blue luminous flux BLL output from the third light source part 30 with the aid of total reflection that occurs at the interface between the air and the glass of which the lightguide member 71 is made to guide the blue luminous flux BLL to the second reflector 73. The first reflector 72 may instead have a configuration in which a reflection film is provided at the end surface of the lightguide member 71.

The second reflector 73 is provided as part of the lightguide member 71 and at a position where the second reflector 73 faces the green light emitting devices 22 of the second light source part 20 that face the third light source part 30. The second reflector 73 inclines by 45 degrees with respect to the light incident surface 71a and is parallel to the first reflector 72. The second reflector 73 is formed of a dielectric multilayer film provided in the lightguide member 71. The second reflector 73 reflects a portion of the blue luminous flux BLL reflected off the first reflector 72 toward the negative end of the X-axis and transmits the other portion of the blue luminous flux BLL toward the negative end of the Y-axis. Furthermore, the second reflector 73 transmits a portion of the green luminous flux GLL from the green light emitting devices 22 toward the negative end of the X-axis. In the present embodiment, the second reflector 73 transmits 50% of the blue luminous flux BLL incident on the second reflector 73 and transmits the other 50%. As described above, the second reflector 73 functions as a half-silvered mirror for the blue luminous flux BLL.

The third reflector 74 is provided as part of the lightguide member 71 and at a position where the third reflector 74 faces the green light emitting devices 22 of the second light source part 20 that are located at the side opposite from the third light source part 30. The third reflector 74 inclines by 45 degrees with respect to the light incident surface 71a and is parallel to the second reflector 73. The third reflector 74 is formed of a dielectric multilayer film provided in the lightguide member 71, as the second reflector 73 is. The third reflector 74 reflects a portion of the blue luminous flux BLL passing through the second reflector 73 toward the negative end of the X-axis and transmits a portion of the green luminous flux GLL from the green light emitting devices 22 toward the positive end of the Y-axis. The third reflector 74 therefore functions as a dichroic mirror that reflects blue light and transmits green light.

Based on the configuration described above, the luminous flux width changer 70 can enlarge the luminous flux width of the blue luminous flux BLL by dividing the blue luminous flux BLL into two luminous fluxes to make the luminous flux width of the blue luminous flux BLL equal to the luminous flux width of the green luminous flux GLL, and can combine the blue luminous flux BLL and the green luminous flux GLL with each other and output the combined luminous flux toward the dichroic mirror 40. The configuration described above suppresses an increase in the size of the dichroic mirror 40, which combines the green luminous flux GLL and the blue luminous flux BLL with the red luminous flux RLL.

In the present embodiment, the luminous flux width changer 70 can adjust the luminous flux width of the blue luminous flux BLL by changing the spacing between the second reflector 73 and the third reflector 74 separated from each other in the Y-axis direction. Furthermore, the luminous flux width changer 70 is so configured that the second reflector 73 and the third reflector 74 are integrated with each other as part of the lightguide member 71, so that the relative positional accuracy between the second reflector 73 and the third reflector 74 is readily improved.

The green luminous flux GLL and the blue luminous flux BLL output from the luminous flux width changer 70 enter the third diffuser 63. The third diffuser 63 is disposed between the second light source part 20 and the dichroic mirror 40.

The third diffuser 63 diffuses the green luminous flux GLL and the blue luminous flux BLL to homogenize the illuminance distributions of the green luminous flux GLL and the blue luminous flux BLL. Furthermore, the third diffuser 63 suppresses speckles produced in the green luminous flux GLL and the blue luminous flux BLL, which degrade the quality of a displayed image. Note that the third diffuser 63 can be any known diffuser plate, for example, a ground glass plate, a holographic diffuser, a transparent substrate having blasted surfaces, and a transparent substrate in which scatterers such as beads are dispersed and scatter light.

The green luminous flux GLL and the blue luminous flux BLL diffused by the third diffuser 63 are incident on the dichroic mirror 40.

The dichroic mirror 40 is disposed at the position where the first optical axis AX1 and the second optical axis AX2 intersect with each other with the dichroic mirror 40 inclining by 45 degrees with respect to the first optical axis AX1 and the second optical axis AX2. The dichroic mirror 40 transmits the red luminous flux RLL incident from the first light source part 10 toward the positive end of the Y-axis, and reflects the green luminous flux GLL and the blue luminous flux BLL incident from the luminous flux width changer 70 toward the positive end of the Y-axis. The thus configured dichroic mirror 40 combines the red luminous flux RLL, the green luminous flux GLL, and the blue luminous flux BLL with one another and outputs the combined luminous flux toward the first light collection system 51.

The first light collection system 51 collects the variety of types of color light incident from the dichroic mirror 40 and directs the collected color light to the first diffuser 61. The first light collection system 51 is formed of a pair of lenses 51a and 51b. The number of lenses that constitute the first light collection system 51 is not limited to a specific number.

Specifically, the first light collection system 51 collects the red luminous flux RLL having passed through the luminous flux width adjuster 50 and the dichroic mirror 40 and the blue luminous flux BLL and the green luminous flux GLL having passed through the luminous flux width changer 70 and the dichroic mirror 40 and directs the collected color light to the first diffuser 61. That is, the red luminous flux RLL collected by the luminous flux width adjuster 50 and the first light collection system 51 enters the first diffuser 61, and the green luminous flux GLL and the blue luminous flux BLL collected by the first light collection system 51 enters the first diffuser 61.

The first diffuser 61 has a light incident surface 61a and a light exiting surface 61b, and outputs the white illumination light WL containing the diffused red luminous flux RLL, green luminous flux GLL, and blue luminous flux BLL via the light exiting surface 61b. The illumination light WL output via the light exiting surface 61b enters the second light collection system 52. The second light collection system 52 is formed of a pair of lenses 52a and 52b. The number of lenses that constitute the second light collection system 52 is not limited to a specific number.

The second light collection system 52 captures the illumination light WL output from the first diffuser 61, converts the captured illumination light WL into substantially parallelized light, and outputs the resultant light toward the homogenizing illumination system 80.

The homogenizing illumination system 80 includes a first lens array 81, a second lens array 82, a polarization converter 83, and a superimposing lens 84.

The first lens array 81 includes a plurality of first lenslets 81a, which divide the illumination light WL output from the second light collection system 52 into a plurality of sub-luminous fluxes. The plurality of first lenslets 81a are arranged in an array in a plane perpendicular to the first optical axis AX1 of the light source apparatus 2. The second lens array 82 includes a plurality of second lenslets 82a. The plurality of second lenslets 82a correspond to the plurality of first lenslets 81a. The first lenslets 81a and the second lenslets 82a each have a square planar shape.

The illumination light WL having passed through the second lens array 82 enters the polarization converter 83.

The polarization converter 83 converts the polarization directions of the light output from the second lens array 82. Specifically, the polarization converter 83 converts a plurality of sub-luminous fluxes output from the second lens array 82 into linearly polarized luminous fluxes.

The polarization converter 83 in the present embodiment includes a plurality of polarization separation layers 83a, a plurality of reflection layers 83b, a plurality of retardation layers 83c, and a light blocking film 83d. The retardation layers 83c are provided on the light exiting side of the polarization converter 83. The polarization converter 83 has a plurality of light incident openings 83K, through which the illumination light WL output from the first diffuser 61 passes. The light incident openings 83K are each formed of an opening formed in the light blocking film 83d disposed on the light incident side of the polarization converter 83. The light incident openings 83K each have a rectangular planar shape having a longitudinal dimension in the axis-Z direction.

In the light source apparatus 2 according to the present embodiment, a secondary light source image of the illumination light WL output via the light exiting surface 61b of the first diffuser 61 is formed in the vicinity of each of the light incident openings 83K, more specifically, between the light exiting surface of the second lens array 82 and each of the light incident openings 83K. Note that the secondary light source image of the illumination light WL can in other words be a tertiary light source images of the red luminous flux RLL output from the first light source part 10, the green luminous flux GLL output from the second light source part 20, and the blue luminous flux BLL output from the third light source part 30.

The present inventor has focused on the fact that differences in size between the red, green, and blue light source images at the light exiting surface 61b of the first diffuser 61 affect the efficiency at which the illumination light WL output from the first diffuser 61 is used. The reason for this is that the amount of illumination light WL passing through the homogenizing illumination system 80 and effectively used as the image light changes in accordance with the sizes of the light source images of the red luminous flux RLL, the green luminous flux GLL, and the blue luminous flux BLL formed on the light incident surface 61a of the first diffuser 61.

The present inventor has found that the efficiency at which the illumination light WL containing the red luminous flux RLL, the green luminous flux GLL, and the blue luminous flux BLL is used by the homogenizing illumination system 80 can be improved by causing the aspect ratios and sizes of the light source images of the red luminous flux RLL, the green luminous flux GLL, and the blue luminous flux BLL formed on the light incident surface 61a of the first diffuser 61 to be similar to one another. Based on the findings, the present inventor achieved the configuration of the light source apparatus 2 according to the present embodiment.

The light source apparatus 2 according to the present embodiment is configured to cause the aspect ratios and sizes of the light source images of the color luminous fluxes RLL, GLL, and BLL, which constitute the illumination light WL, to be similar to one another by causing the red luminous flux RLL to be incident on the light incident surface 61a of the first diffuser 61 with the red luminous flux RLL defocused and causing the green luminous flux GLL and the blue luminous flux BLL to be incident on the light incident surface 61a of the first diffuser 61 with the green luminous flux GLL and the blue luminous flux BLL focused to adjust the aspect ratio and size of the light source image formed by the red luminous flux RLL at the light incident surface 61a of the first diffuser 61, as will be described later.

More specifically, the luminous flux width adjuster 50 and the first light collection system 51 are configured to collect the red luminous flux RLL in such a way that the aspect ratio and size of a first light source image KG1, which is formed by the red luminous flux RLL at the light incident surface 61a of the first diffuser 61, approach the aspect ratio and size of a second light source image KG2, which is formed by the green luminous flux GLL at the light incident surface 61a of the first diffuser 61.

The configuration of the light source apparatus 2 according to the present embodiment will be described below.

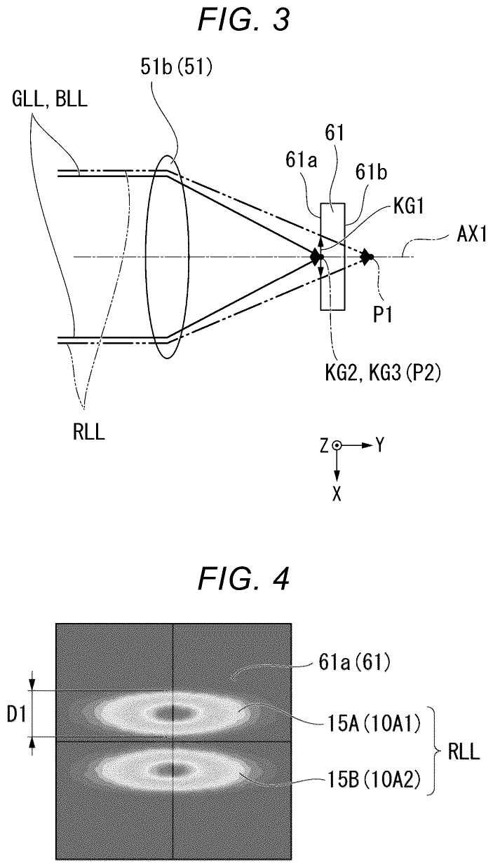

FIG. 3 shows the light source images formed on the light incident surface 61a of the first diffuser 61 via the first light collection system 51.

In the present embodiment, the red luminous flux RLL is collected by the luminous flux width adjuster 50 and the first light collection system 51 at a first light collection position P1 on the line extending in the Y-direction, which is the optical axis direction of the first light collection system 51, as shown in FIG. 3. That is, the red luminous flux RLL output from the first light source part 10 and traveled via the luminous flux width adjuster 50, the dichroic mirror 40, and the first light collection system 51 is collected at the first light collection position P1 on the line extending in the optical axis direction of the first light collection system 51.

In the present embodiment, the first light collection position P1, at which the red luminous flux RLL is collected, is downstream from the light incident surface 61a of the first diffuser 61 (shifted toward positive end of Y-axis). That is, the red luminous flux RLL is incident on the light incident surface 61a of the first diffuser 61 with the red luminous flux RLL defocused.

The green luminous flux GLL and the blue luminous flux BLL are collected by the first light collection system 51 at a second light collection position P2 different from the first light collection position P1 in the Y-direction. That is, the green luminous flux GLL output from the second light source part 20 and traveled via the dichroic mirror 40 and the first light collection system 51 is collected at the second light collection position P2 different from the first light collection position P1 in the Y-direction. The blue luminous flux BLL output from the third light source part 30 and traveled via the dichroic mirror 40 and the first light collection system 51 is collected at the second light collection position P2, as the green luminous flux GLL is.

In the present embodiment, the second light collection position P2, at which the green luminous flux GLL and the blue luminous flux BLL are collected, is located at the light incident surface 61a of the first diffuser 61. That is, the green luminous flux GLL and the blue luminous flux BLL are incident on the light incident surface 61a of the first diffuser 61 with the two luminous fluxes focused.

Therefore, the red luminous flux RLL is incident on the light incident surface 61a of the first diffuser 61 with the red luminous flux RLL being divergent, which is the state before the red luminous flux RLL is brought into focus, and the green luminous flux GLL and the blue luminous flux BLL enter the first diffuser 61 with the two luminous fluxes brought into focus at the light incident surface 61a.

The red luminous flux RLL forms the first light source image KG1 on the light incident surface 61a of the first diffuser 61, and the green luminous flux GLL and the blue luminous flux BLL form the second light source image KG2 and a third light source image KG3, respectively, on the light incident surface 61a of the first diffuser 61.

In the light source apparatus 2 according to the present embodiment, the secondary light source image of the illumination light WL output via the light exiting surface 61b of the first diffuser 61 is formed in the vicinity of each of the light incident openings 83K of the polarization converter 83. In the present embodiment, the second lenslets 82a of the second lens array 82 each have a square planar shape.

To describe the effect provided by the configuration of the light source apparatus 2 according to the present embodiment, the following configuration will be described as Comparative Example: The red luminous flux RLL, the green luminous flux GLL, and the blue luminous flux BLL are each incident on the light incident surface 61a of the first diffuser 61 with all the luminous fluxes being focused, and the red luminous flux RLL, the green luminous flux GLL, and the blue luminous flux BLL form respective light source images on the light incident surface 61a.

At the first light collection position P1, the plurality of beams of the red light RL, which constitute the red luminous flux RLL, are superimposed on one another. The first light emitting regions 10A of the first light source part 10 each includes the first light emitting section 10A1 and the second light emitting section 10A2, as shown in FIG. 2. The light source image of the red luminous flux RLL, which is superimposition of the beams of the red light RL, is formed of a light source image formed by the light emitted from the first light emitting section 10A1 and a light source image formed by the light emitted from the second light emitting section 10A2.

FIG. 4 shows the light source image of the red luminous flux RLL formed by the configuration of Comparative Example on the light incident surface 61a of the first diffuser 61.

The light source image of the red luminous flux RLL is formed of a first elliptical light source image 15A formed by the first light emitting section 10A1 and a second elliptical light source image 15B formed by the second light emitting section 10A2, as shown in FIG. 4. The first elliptical light source image 15A and the second elliptical light source image 15B each have an elliptical shape. The second elliptical light source image 15B is formed at a position shifted from the first elliptical light source image 15A in the direction of a minor axis D1. The first elliptical light source image 15A and the second elliptical light source image 15B have a common minor axis direction. As described above, the light source image formed on the light incident surface 61a by the red luminous flux RLL, which is brought into focus at the light incident surface 61a, has a rectangular shape having long sides extending in one direction, so that the light source image of the red luminous flux RLL has an aspect ratio separate from 1:1.

The light source images formed on the light incident surface 61a of the first diffuser 61 by the green luminous flux GLL and the blue luminous flux BLL will be subsequently described. Since the light source image of the blue luminous flux BLL has a shape that is the same as the shape of the light source image of the green luminous flux GLL, the following description will be made with reference to the light source image of the green luminous flux GLL.

At the second light collection position P2, the plurality of beams of the green light GL, which constitute the green luminous flux GLL, are superimposed on one another. The second light emitting regions 20A of the second light source part 20 each include one light emitting point, as shown in FIG. 2. The light source image of the green luminous flux GLL, which is superimposition of the beams of the green light GL on one another, is therefore formed of the image of the light emitted from one light emitting point.

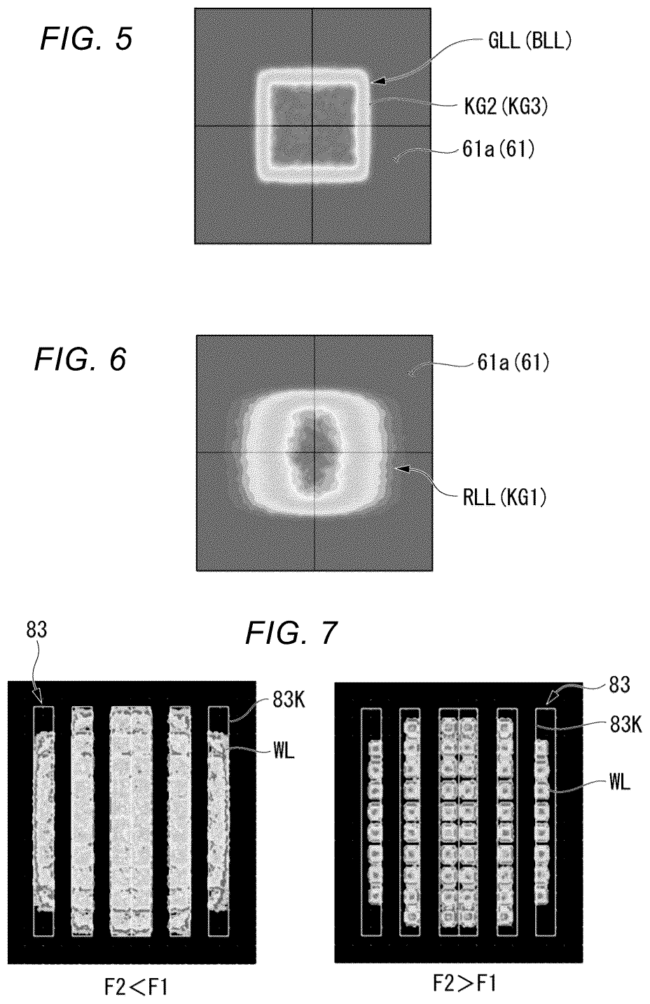

FIG. 5 shows the light source image of the green luminous flux GLL formed on the light incident surface 61a of the first diffuser 61. The light source image of the green luminous flux GLL, which is superimposition of the images of the beams of the green light GL on one another, has a substantially square shape, as shown in FIG. 5. The second light source image KG2 formed by the green luminous flux GLL and having a substantially square shape as described above has an aspect ratio close to 1:1. Similarly, the third light source image KG3 of the blue luminous flux BLL has an aspect ratio close to 1:1.

That is, when the red luminous flux RLL, the green luminous flux GLL, and the blue luminous flux BLL are each incident on the light incident surface 61a of the first diffuser 61 with all the luminous fluxes being focused, the light source image of the red luminous flux RLL and the light source images of the green luminous flux GLL and the blue luminous flux BLL all formed on the light incident surface 61a of the first diffuser 61 unfortunately have different aspect ratios and sizes.

In contrast, in the light source apparatus 2 according to the present embodiment, in which the red luminous flux RLL is incident on the light incident surface 61a of the first diffuser 61 with the red luminous flux RLL defocused, the first elliptical light source image 15A and the second elliptical light source image 15B of the light output from the first light emitting section 10A1 and the second light emitting section 10A2 of each of the first light emitting regions 10A of the first light source part 10 are blurred. The first elliptical light source image 15A and the second elliptical light source image 15B therefore partially overlap with each other on the light incident surface 61a of the first diffuser 61.

FIG. 6 shows the light source image of the red luminous flux RLL formed on the light incident surface 61a of the first diffuser 61 in the light source apparatus 2 according to the present embodiment.

The light source image formed by the defocused red luminous flux RLL on the light incident surface 61a of the first diffuser 61, which is the integration of the light source images of the plurality of luminous fluxes, has as a whole a substantially square shape, as shown in FIG. 6. That is, in the light source apparatus 2 according to the present embodiment, the first light source image KG1 of the red luminous flux RLL formed on the light incident surface 61a of the first diffuser 61 has an aspect ratio close to the aspect ratio of 1:1, which is the aspect ratio of the light source image of each of the green luminous flux GLL and the blue luminous flux BLL shown in FIG. 5.

The first diffuser 61 in the present embodiment diffuses the color luminous fluxes RLL, GLL, and BLL by the same degree. That is, at the light incident surface 61a of the first diffuser 61, when the light source images of the color luminous fluxes RLL, GLL, and BLL have approximately the same aspect ratios and sizes, the color luminous fluxes RLL, GLL, and BLL are diffused by the same degree by the time when the color luminous fluxes pass through the first diffuser 61. The light emitting regions from which the color luminous fluxes RLL, GLL, and BLL are emitted therefore have approximately the same light emitting region shape at the light exiting surface 61b of the first diffuser 61.

The light source apparatus 2 according to the present embodiment, in which the luminous flux width adjuster 50 and the first light collection system 51 collect the red luminous flux RLL, allows the aspect ratio and size of the first light source image KG1 of the red luminous flux RLL formed at the light incident surface 61a of the first diffuser 61 to be equal to the aspect ratios and sizes of the second light source image KG2 of the green luminous flux GLL and the third light source image KG3 of the blue luminous flux BLL formed at the light incident surface 61a of the first diffuser 61. The aspect ratios and sizes of the light emitting regions from which the variety of types of color light contained in the illumination light WL are emitted can therefore be made equal to one another at the light exiting surface 61b of the first diffuser 61.

The light source apparatus 2 according to the present embodiment, in which the light emitting regions from which the illumination light WL is emitted have the same aspect ratio of 1:1 at the light exiting surface 61b of the first diffuser 61, via which the illumination light WL is output, allows the planar shapes of the light emitting regions from which the illumination light WL is emitted to approach the planar shape of each of the second lenslets 82a (square) of the second lens array 82. Therefore, the divided luminous fluxes into which the illumination light WL is divided by the first lenslets 81a of the first lens array 81 are unlikely to stick out of the second lenslets 82a, so that the illumination light WL can efficiently pass through the second lenslets 82a and form the secondary light source image at each of the light incident openings 83K.

The homogenizing illumination system 80 can therefore efficiently capture the illumination light WL output from the first diffuser 61 via each of the light incident openings 83K of the polarization converter 83.

The present inventor has found based on a simulation that setting the focal length of the second light collection system 52 and the focal length of the first light collection system 51 to relate to each other in a predetermined relationship allows the illumination light WL to efficiently enter the homogenizing illumination system 80.

Specifically, in the light source apparatus 2 according to the present embodiment, the focal length of the second light collection system 52 is longer than the focal length of the first light collection system 51.

FIG. 7 shows the results of the simulation. The left portion of FIG. 7 shows the configuration of Comparative Example, in which a focal length F2 of the second light collection system 52 is shorter than a focal length F1 of the first light collection system 51, and the right portion of FIG. 7 shows the configuration of the present embodiment, in which the focal length F2 of the second light collection system 52 is longer than the focal length F1 of the first light collection system 51.

When the focal length F2 of the second light collection system 52 is longer than the focal length F1 of the first light collection system 51 (F2>F1), it has been ascertained that the light source image of the illumination light WL incident on each of the light incident openings 83K of the polarization converter 83 is smaller than that formed when the focal length F2 of the second light collection system 52 is shorter than the focal length F1 of the first light collection system 51 (F2<F1), as shown in FIG. 7. That is, making the focal length F2 of the second light collection system 52 longer than the focal length F1 of the first light collection system 51 makes the light source image of the illumination light WL smaller, so that it has been ascertained that the amount by which the illumination light WL is truncated by each of the light incident openings 83K can be suppressed.

The light source apparatus 2 according to the present embodiment, in which the focal length of the second light collection system 52 is longer than the focal length of the first light collection system 51, can suppress the amount by which the illumination light WL is truncated by the light incident openings 83K.

As described above, the light source apparatus 2 according to the present embodiment includes the first light source part 10, which outputs the red luminous flux RLL containing the red light RL emitted from the first light emitting regions 10A, the second light source part 20, which outputs the green luminous flux GLL containing the green light GL emitted from the second light emitting regions 20A each having a planar shape different from that of each of the first light emitting regions 10A and having a wavelength band different from that of the red light RL, the third light source part 30, which outputs the blue luminous flux BLL having a wavelength band different from those of the red luminous flux RLL and the green luminous flux GLL, the dichroic mirror 40, which combines the red luminous flux RLL, the green luminous flux GLL, and the blue luminous flux BLL with one another, the luminous flux width adjuster 50, which is disposed between the dichroic mirror 40 and the first light source part 10 and makes adjustment of reducing the difference in the luminous flux width between the red luminous flux RLL and the green luminous flux GLL, the first light collection system 51, which collects the light output from the dichroic mirror 40, and the first diffuser 61, which the light output from the first light collection system 51 enters. The luminous flux width adjuster 50 has a finite focal length.

The red luminous flux RLL output from the first light source part 10 and traveled via the luminous flux width adjuster 50, the dichroic mirror 40, and the first light collection system 51 is collected at the first light collection position P1 on the line extending in the optical axis direction of the first light collection system 51. The green luminous flux GLL output from the second light source part 20 and traveled via the dichroic mirror 40 and the first light collection system 51 is collected at the second light collection position P2 different from the first light collection position P1 in the optical axis direction. The luminous flux width adjuster 50 and the first light collection system 51 collect the red luminous flux RLL in such a way that the aspect ratio and size of the first light source image KG1, which is formed by the red luminous flux RLL at the light incident surface 61a of the first diffuser 61, approach the aspect ratio and size of the second light source image KG2, which is formed by the green luminous flux GLL at the light incident surface 61a of the first diffuser 61.

The light source apparatus 2 according to the present embodiment, in which the light collection position where the red luminous flux RLL output from the first light source part 10 is collected differs from the light collection positions where the green luminous flux GLL output from the second light source part 20 and the blue luminous flux BLL output from the third light source part 30 are collected, allows the light source images formed at the light incident surface 61a of the first diffuser 61 to have the same aspect ratio and size to allow the light emitting regions from which the variety of types of color light contained in the illumination light WL are emitted to have the same aspect ratio and size at the first diffuser 61. The configuration described above allows an increase in the efficiency at which the illumination light WL output from the first diffuser 61 is used by the homogenizing illumination system 80.

When the sizes of the light emitting regions from which the variety of types of color light contained in the illumination light WL are emitted vary at the light exiting surface 61b of the first diffuser 61, the light source apparatus 2 needs to be designed in accordance with the size of the largest light emitting region to allow the homogenizing illumination system 80 to efficiently capture the variety of types of color light. In this case, the sizes of the component parts of the homogenizing illumination system 80 need to be increased, resulting in an increase in the size of the projector. In contrast, the light source apparatus 2 according to the present embodiment, in which the light emitting regions from which the variety of types of color light contained in the illumination light WL are emitted have the same size as described above, can suppress the increase in the sizes of the component parts of the homogenizing illumination system 80, resulting in a reduction in the size of the projector 1.

The light source apparatus 2 according to the present embodiment, in which the light emission areas of the variety of color luminous fluxes that constitute the illumination light WL output via the light exiting surface 61b of the first diffuser 61 have no difference, is unlikely to produce differences in illuminance distribution among the variety of colors at the homogenizing illumination system 80 located downstream from the first diffuser 61.

The projector 1 according to the present embodiment, which includes the light source apparatus 2, which provides increased efficiency at which the illumination light WL is used, can be a projector that operates at high light use efficiency and displays a bright image.

Furthermore, since the red light LR, the green light LG, and the blue light LB, into which the illumination light WL is divided and which have no difference in the illuminance distribution, enter the light modulators 4R, 4G, and 4B, variation in the distribution of the angle of incidence of the light incident on the light modulators 4R, 4G, and 4B and hence color unevenness are suppressed, so that a higher-quality projection image can be produced.

The technical scope of the present disclosure is not limited to the embodiment described above, and a variety of changes can be made thereto to the extent that the changes do not depart from the intent of the present disclosure.

In addition to the above, the number, arrangement, shape, material, and other specific factors of the variety of components that constitute the projector are not limited to those in the embodiment described above and can be changed as appropriate.

For example, the aforementioned embodiment has been described with reference to the case where the luminous flux width changer 70 combines the green luminous flux GLL output from the second light source part 20 and the blue luminous flux BLL output from the third light source part 30 with each other, and a luminous flux width changer that combines the red luminous flux RLL output from the first light source part 10 with the blue luminous flux BLL output from the third light source part 30 may be disposed. In this case, the luminous flux width adjuster 50 adjusts the luminous flux widths of the red luminous flux RLL and the blue luminous flux BLL to reduce the differences of the luminous flux widths of the red luminous flux RLL and the blue luminous flux BLL from the luminous flux width of the green luminous flux GLL output from the second light source part 20.

Furthermore, the luminous flux width adjuster 50 in the embodiment described above has been described with reference to the case where the luminous flux width of the red luminous flux RLL is made equal to the luminous flux widths of the green luminous flux GLL and the blue luminous flux BLL by reducing the luminous flux width of the red luminous flux RLL after the red luminous flux RLL enters the luminous flux width adjuster 50 as compared with the luminous flux width before the red luminous flux RLL enters the luminous flux width adjuster 50, and the luminous flux width of the red luminous flux RLL may instead be made equal to the luminous flux widths of the green luminous flux GLL and the blue luminous flux BLL by increasing the luminous flux width of the red luminous flux RLL after the red luminous flux RLL enters the luminous flux width adjuster 50 as compared with the luminous flux width before the red luminous flux RLL enters the luminous flux width adjuster 50.

The present disclosure will be summarized below as additional remarks.

### Additional Remark 1

A light source apparatus including a first light source part that outputs a first luminous flux containing first color light emitted from a first light emitting region, a second light source part that outputs a second luminous flux containing second color light emitted from a second light emitting region having a planar shape different from the planar shape of the first light emitting region and having a wavelength band different from the wavelength band of the first color light, a combiner that combines the first luminous flux and the second luminous flux with each other, a luminous flux width adjuster that is disposed between the combiner and the first light source part and adjusts to reduce the difference in the luminous flux width between the first luminous flux and the second luminous flux, a first light collection system that collects the light output from the combiner, a first diffuser that the light output from the first light collection system enters, a second light collection system that the light output from the first diffuser enters, and a homogenizing illumination system that the light output from the second light collection system enters, the luminous flux width adjuster having a finite focal length, the first luminous flux output from the first light source part and traveling via the luminous flux width adjuster, the combiner, and the first light collection system collected at a first light collection position on the line extending in the optical axis direction of the first light collection system, the second luminous flux output from the second light source part and traveling via the combiner and the first light collection system collected at a second light collection position different from the first light collection position in the optical axis direction, and the luminous flux width adjuster and the first light collection system collecting the first luminous flux in such a way that the aspect ratio and size of a first light source image formed by the first luminous flux at a light incident surface of the first diffuser approach the aspect ratio and size of a second light source image formed by the second luminous flux at the light incident surface of the first diffuser.

The thus configured light source apparatus, in which the light collection position where the first luminous flux output from the first light source part is collected differs from the light collection position where the second luminous flux output from the second light source part is collected, allows the light source images formed by the light source fluxes at the light incident surface of the first diffuser to have the same aspect ratio and size to allow the light emitting regions from which the first and second luminous fluxes are emitted to have the same aspect ratio and size at the first diffuser. The configuration described above allows an increase in the efficiency at which the first and second luminous fluxes output from the first diffuser are used by the homogenizing illumination system.

### Additional Remark 2

The light source apparatus described in the additional remark 1, in which when the second light emitting region has an aspect ratio closer to 1:1 than the first light emitting region, the light incident surface of the first diffuser is disposed at the second light collection position where the second luminous flux is collected, and the first luminous flux is incident on the light incident surface of the first diffuser with the first luminous flux defocused.

The configuration described above, in which the first luminous flux is incident on the light incident surface of the first diffuser with the first luminous flux defocused, allows the aspect ratio of the first light source image formed on the light incident surface of the first diffuser to approach 1:1 and further allows the first and second light source images to have the same aspect ratio and size.

### Additional Remark 3

The light source apparatus described in the additional remark 1 or 2, further including a third light source part that outputs a third luminous flux containing third color light having a wavelength band different from the wavelength bands of the first and second luminous fluxes, and a luminous flux width changer that causes the luminous flux width of the third luminous flux to approach the luminous flux width of one of the first and second luminous fluxes and combines the one luminous flux with the third luminous flux, the combiner combining the first and second luminous fluxes with the third luminous flux.

The configuration described above, in which the luminous flux width changer adjusts the luminous flux width of the third luminous flux, allows the first, second, and third luminous fluxes to have the same luminous flux width. An increase in the size of the combiner, which combines the first, second, and third luminous fluxes with one another, can thus be suppressed.

### Additional Remark 4

The light source apparatus described in the additional remark 3, in which the first color light is red light, the second color light is green light, and the third color light is blue light.

The configuration described above allows an increase in the efficiency at which the white illumination light output from the first diffuser is used by the homogenizing illumination system.

### Additional Remark 5

The light source apparatus described in any one of the additional remarks 1 to 4, in which the focal length of the second light collection system is longer than the focal length of the first light collection system.

The configuration described above, which reduces the sizes of the light source images of the first color light and the second color light, can suppress the amount by which the first color light and the second color light are truncated by the homogenizing illumination system.

### Additional Remark 6

The light source apparatus described in any one of the additional remarks 1 to 5, further including a second diffuser disposed between the first light source part and the combiner, and a third diffuser disposed between the second light source part and the combiner.

The configuration described above, in which the second and third diffusers diffuse the first and second luminous fluxes, respectively, can homogenize the illuminance distributions of the first and second luminous fluxes. For example, when the first and second luminous fluxes are each laser light, speckles that are produced by the first and second luminous fluxes and degrade the quality of a displayed image can be suppressed.

### Additional Remark 7

The light source apparatus described in the additional remark 2, in which the first light emitting region of the first light source part includes a first light emitting section and a second light emitting section, the light output from the first light emitting section forms a first elliptical light source image at the first light collection position, the light output from the second light emitting section forms a second elliptical light source image at the first light collection position but shifted from the first elliptical light source image in the minor axis direction thereof, and the first and second elliptical light source images have a common minor axis direction.

According to the configuration described above, the first and second elliptical light source images are close to each other or partially overlap with each other on the light incident surface of the first diffuser with the first and second elliptical light source images blurred. The first light source image formed by the first luminous flux on the light incident surface of the first diffuser, which is the integration of the images of a plurality of luminous fluxes, has as a whole a substantially square shape. The aspect ratio of the first light source image formed on the light incident surface of the first diffuser can thus approach 1:1.

### Additional Remark 8

A projector including the light source apparatus described in any one of the additional remarks 1 to 7, a light modulator that modulates the light from the light source apparatus to generate image light, and a projection optical apparatus that projects the image light.

The thus configured projector, which includes the light source apparatus that provides increased light use efficiency, can operate at high light use efficiency and display a bright image.

Furthermore, since color light beams having no difference in the illuminance distribution enter the light modulators, color unevenness is suppressed, so that a higher-quality projection image can be produced.

What is claimed is:

1. A light source apparatus comprising:
a first light source part that outputs a first luminous flux containing first color light emitted from a first light emitting region;
a second light source part that outputs a second luminous flux containing second color light emitted from a second light emitting region having a first planar shape different from a second planar shape of the first light emitting region and having a first wavelength band different from a second wavelength band of the first color light;
a combiner that combines the first luminous flux and the second luminous flux with each other;
a luminous flux width adjuster that is disposed between the combiner and the first light source part and reduces a difference in a luminous flux width between the first luminous flux and the second luminous flux;
a first light collection system that collects light emitted from the combiner;
a first diffuser that the light emitted from the first light collection system enters;
a second light collection system that light emitted from the first diffuser enters; and
a homogenizing illumination system that light emitted from the second light collection system enters,
wherein the luminous flux width adjuster has a finite focal length,
the first luminous flux emitted from the first light source part and traveling via the luminous flux width adjuster, the combiner, and the first light collection system is collected at a first light collection position on a line extending in an optical axis direction of the first light collection system,
the second luminous flux emitted from the second light source part and traveling via the combiner and the first light collection system is collected at a second light collection position different from the first light collection position in the optical axis direction, and
the luminous flux width adjuster and the first light collection system collect the first luminous flux in such a way that an aspect ratio and a size of a first light source image formed by the first luminous flux at a light incident surface of the first diffuser approach an aspect ratio and a size of a second light source image formed by the second luminous flux at the light incident surface of the first diffuser.

2. The light source apparatus according to claim 1,
wherein when the second light emitting region has an aspect ratio closer to 1:1 than the first light emitting region,
the light incident surface of the first diffuser is disposed at the second light collection position where the second luminous flux is collected, and
the first luminous flux is incident on the light incident surface of the first diffuser with the first luminous flux defocused.

3. The light source apparatus according to claim 1, further comprising:
a third light source part that outputs a third luminous flux containing third color light having a wavelength band different from the wavelength bands of the first and second luminous fluxes; and
a luminous flux width changer that makes a luminous flux width of the third luminous flux to approach the luminous flux width of one of the first and second luminous fluxes and combines the one luminous flux with the third luminous flux,
wherein the combiner combines the first and second luminous fluxes with the third luminous flux.

4. The light source apparatus according to claim 3,
wherein the first color light is red light,
the second color light is green light, and
the third color light is blue light.

5. The light source apparatus according to claim 1,
wherein a focal length of the second light collection system is longer than a focal length of the first light collection system.

6. The light source apparatus according to claim 1, further comprising:
a second diffuser disposed between the first light source part and the combiner; and
a third diffuser disposed between the second light source part and the combiner.

7. The light source apparatus according to claim 2,
wherein the first light emitting region of the first light source part includes a first light emitting section and a second light emitting section,
light output from the first light emitting section forms a first elliptical light source image at the first light collection position,
light output from the second light emitting section forms a second elliptical light source image at the first light collection position but shifted from the first elliptical light source image in a minor axis direction thereof, and
the first and second elliptical light source images have a common minor axis direction.

8. A projector comprising:
the light source apparatus according to claim 1;
a light modulator that modulates light from the light source apparatus to generate image light; and
a projection optical apparatus that projects the image light.
